(19) United States
(12) Patent Application Publication
(10) Pub. No.: US 2010/0269700 A1
(43) Pub. Date: Oct. 28, 2010

(54) VACUUM ADSORPTION APPARATUS

(76) Inventor: Zhen-Zhong HAN, Taiping City (TW)

Correspondence Address: Ching-Ling Huang, 5597 NW 127th Ter, Portland, OR, 97229, US

(21) Appl. No.: 12/428,460

(22) Filed: Apr. 22, 2009

(51) Int. Cl. B01D 53/047

(52) U.S. Cl. 96/114

(57) ABSTRACT

A vacuum adsorption apparatus is connected to a workstation and a vacuum pump and includes a vacuum tank and a sensor. The vacuum tank is respectively connected to the workstation and the vacuum pump through a plurality of ducts. The sensor is respectively connected to the vacuum tank and the vacuum pump to form a detection loop to detect the vacuum conditions of the workstation and the vacuum tank, and control the operation of the vacuum pump.

### FIELD OF THE INVENTION

The present invention relates to an adsorption workstation and particularly to a vacuum adsorption apparatus.

### BACKGROUND OF THE INVENTION

In processes of spray painting, material cutting or other precision industries, vacuum adsorption means is often being used to temporarily hold and anchor non-magnetic and non-clampable products.

FIG. 1 illustrates a conventional vacuum adsorption apparatus that has a workstation 1 and an air compressor 2. The workstation 1 has a plurality of adsorption apertures 3 to withdraw air through the air compressor 2 to adsorb an article (not shown in the drawing). The air compressor 2 is the power source. When in use for adsorbing the article through the workstation 1, a selected adsorption area is bordered by a rubber frame (not shown in the drawing), while the rest of the adsorption apertures 3 are plugged. Then the air compressor 2 is activated to generate vacuum to adsorb the article. The air compressor 2 has to operate continuously to maintain the vacuum adsorption effect. It incurs waste of electric power and results in a higher cost.

### SUMMARY OF THE INVENTION

Therefore, the primary object of the present invention is to provide a vacuum adsorption apparatus to incorporate with a workstation and a vacuum pump. The apparatus according to the invention includes a vacuum tank and a sensor. The vacuum tank is respectively connected to the workstation and the vacuum pump. The sensor is respectively connected to the vacuum tank and the vacuum pump. Thus a detection loop is formed to detect and control the vacuum condition of the workstation.

When the invention is used in the production process of a precision industry, the vacuum pump does not need to operate continuously. After the vacuum pump has withdrawn the air, the sensor in the detection loop detects the adsorption pressure of the workstation. If the detected pressure reaches a pre-set value, the vacuum pump stops operation. On the other hand, if the adsorption pressure of the workstation drops below a selected level, the vacuum pump resumes operation.

By means of the technique set forth above, the vacuum adsorption apparatus of the invention can provide the following advantages:

1. The invention provides a detection loop through a sensor in the production process. When the adsorption pressure of the workstation reaches a pre-set value, the vacuum pump stops or resumes operation. Hence the life span of the vacuum pump increases. The cost also is lower.

2. The vacuum tank can store withdrawn air and also offer a pressure detection spot to facilitate detection ability of the sensor. The workstation in the conventional technique has a duct connecting under an adsorption aperture to provide partial pressure of the vacuum pressure that could cause detection insensitivity of the sensor. With the vacuum tank provided by the invention to store the air and provide pressure measurement detection of the pressure by the sensor improves.

The foregoing, as well as additional objects, features and advantages of the invention will be more readily apparent from the following detailed description, which proceeds with reference to the accompanying embodiment and drawings. The embodiment serves only for illustrative purpose and is not the limitation of the invention.

### BRIEF DESCRIPTION OF THE DRAWINGS

FIG. 1 is a schematic view of a conventional adsorption station.

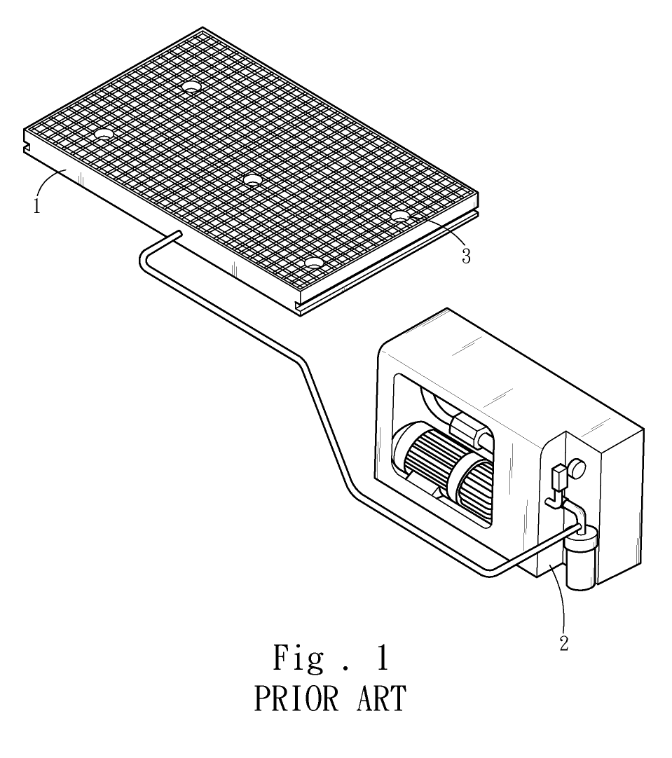

FIG. 2 is a schematic view of the vacuum adsorption apparatus of the invention.

FIG. 3 is a schematic view of an embodiment of the vacuum adsorption apparatus of the invention.

### DETAILED DESCRIPTION OF THE PREFERRED EMBODIMENT

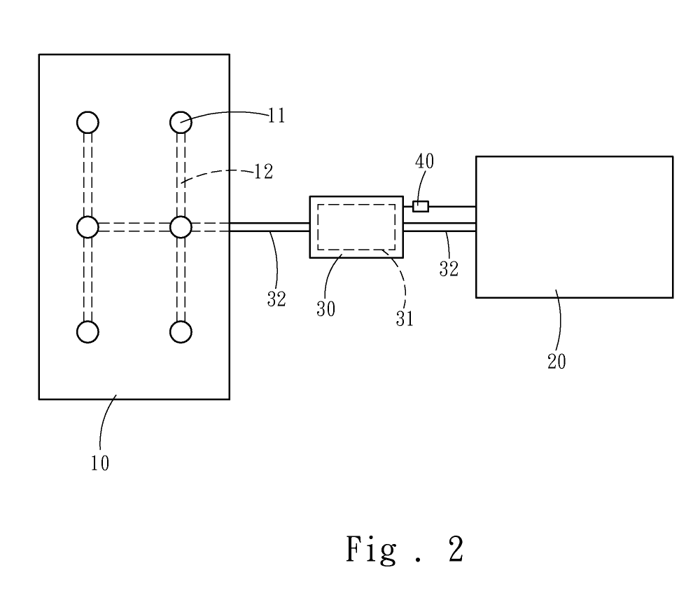

Please refer to FIG. 2, the vacuum adsorption apparatus of the invention is connected to a workstation 10 and a vacuum pump 20 when in use. It includes a vacuum tank 30 and a sensor 40. The vacuum tank 30 is a closed barrel and has a housing chamber 31 inside. The vacuum tank 30 is respectively connected to the workstation 10 and the vacuum pump 20 through ducts 32. The workstation 10 has at least one adsorption aperture 11 communicating with each other and converging through at least one channel tube 12. The channel tube 12 is connected to the duct 32. The sensor 40 is respectively connected to the vacuum tank 30 and the vacuum pump 20. Thus a detection loop is formed to detect and control vacuum conditions of the workstation 10.

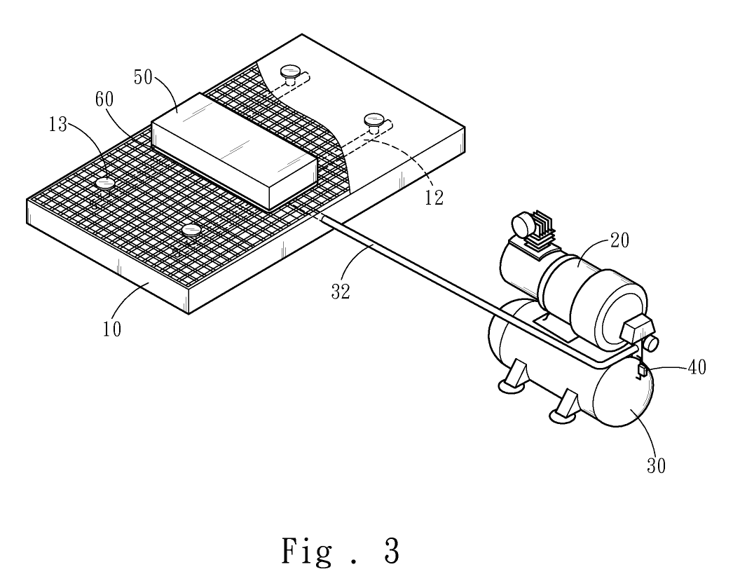

Please refer to FIG. 3 for an embodiment of the invention in use condition on a precision production process. The workstation 10 has a pre-set adsorption area (not shown in the drawing) for an article 50 framed by a rubber frame 60 for holding the article 50. Other adsorption apertures 11 outside the rubber frame 60 are plugged by at least one upper cap 13. Then the vacuum pump 20 is activated to withdraw the air through the adsorption apertures 11 in the rubber frame 60 into the vacuum tank 30 to maintain a negative pressure to adsorb the article 50. Because of the detection loop containing the sensor 40, the vacuum pump 20 does not have to operate continuously. When the sensor 40 detects the negative pressure value of the vacuum tank 30 has reached a pre-set value, the vacuum pump 20 stops operation. On the other hand, in the event that the adsorption pressure value of the vacuum tank 30 has dropped below another pre-set value, the vacuum pump 20 resumes operation.

Thus with the invention adopted in the industrial production process, through the sensor 40 and the detection loop, when the adsorption pressure of the workstation 10 has reached a pre-set vale, the vacuum pump 20 starts or stops operation. Therefore, the life span of the vacuum pump 20 increases. The cost also is lower. Moreover, the vacuum tank 30 stores the adsorbed air and provides desired spots for pressure detection and can improve detection ability of the sensor 40. This also overcomes another problem of the conventional technique which has a channel tube 12 connecting under the adsorption aperture 11 of the workstation 10 to provide a partial pressure that results in detection insensitivity of the sensor 40. By providing the vacuum tank 30 to store pressure and air, the sensor 40 can function better.

What is claimed is:

1. A vacuum adsorption apparatus connecting to a workstation and a vacuum pump, comprising:
a vacuum tank which is a closed barrel and has a housing chamber inside and is respectively connected to the workstation and the vacuum pump through a plurality of ducts; and
a sensor respectively connecting to the vacuum tank and the vacuum pump to form a detection loop to detect and control vacuum conditions of the workstation.

2. The vacuum adsorption apparatus of claim 1, wherein the workstation has at least one adsorption aperture communicating with each other and converging through at least one channel tube.

3. The vacuum adsorption apparatus of claim 2, wherein the channel tube is connected to the duct.

4. The vacuum adsorption apparatus of claim 1, wherein the workstation has a pre-set adsorption area for an article, the adsorption area is framed by a rubber frame to mate the adsorption aperture in the adsorption area to serve as a function area.

5. The vacuum adsorption apparatus of claim 4, wherein each adsorption aperture outside the adsorption area has at least one mating upper cap.
